(19) United States
(12) Patent Application Publication
(10) Pub. No.: US 2016/0350543 A1
(43) Pub. Date: Dec. 1, 2016

(54) ELECTRONIC DEVICE AND METHOD OF ACCESSING KERNEL DATA

(71) Applicants: Samsung Electronics Co., Ltd., Suwon-si (KR); KOREA ADVANCED INSTITUTE OF SCIENCE AND TECHNOLOGY, Daejeon (KR)

(72) Inventors: Sunjune KONG, Suwon-si (KR); ByungHoon Brent KANG, Daejeon (KR)

(21) Appl. No.: 15/166,909

(22) Filed: May 27, 2016

(30) Foreign Application Priority Data
May 29, 2015 (KR) 10-2015-0076420

(51) Int. Cl. G06F 21/60; G06F 21/56

(52) U.S. Cl. CPC G06F 21/604; G06F 21/566; G06F 21/567; G06F 2221/034

(57) ABSTRACT

A method for an electronic device to access kernel data is provided. The method includes transmitting data associated with a kernel symbol to a secure world that is included in a normal world, determining whether a normal world kernel data observation request exists, when the normal world kernel data observation request exists, adjusting the allocation of a virtual memory address space of the secure world, transmitting the normal world kernel data from the normal world to the secure world, loading the normal world kernel data into a virtual address space of the secure world, linking the data associated with the kernel symbol to the normal world kernel data, and observing the normal world kernel data that is loaded into the virtual address space of the secure world, wherein the data associated with the kernel symbol is included in the normal world when the electronic device is booted.

### CROSS-REFERENCE TO RELATED APPLICATION(S)

This application claims the benefit under 35 U.S.C. §119(a) of a Korean patent application filed on May 29, 2015 in the Korean Intellectual Property Office and assigned Serial number 10-2015-0076420, the entire disclosure of which is hereby incorporated by reference.

### JOINT RESEARCH AGREEMENT

The present disclosure was made by or on behalf of the below listed parties to a joint research agreement. The joint research agreement was in effect on or before the date the present disclosure was made and the present disclosure was made as a result of activities undertaken within the scope of the joint research agreement. The parties to the joint research agreement are 1) SAMSUNG ELECTRONICS CO., LTD. and 2) KOREA ADVANCED INSTITUTE OF SCIENCE AND TECHNOLOGY.

### TECHNICAL FIELD

The present disclosure relates to a method for software of a secure world to efficiently access kernel data that is operated in a normal world and an electronic device including the method.

### BACKGROUND

As portable electronic devices (such as smart phones, tablet personal computers (PC), or the like) have become popular, the hardware and software of the electronic devices have also been dramatically developed, and thus, the service environment of the portable electronic devices has become similar to that of PCs. Also, convenient functions that are desired by users are provided through downloading various applications from the Internet, App Store, or the like.

However, when various applications are downloaded, malignant applications containing a malignant code, spyware, or the like may inflow into the portable electronic device, and thus, may cause damage by cyber attacks, such as network traffic, system performance deterioration, file deletion, personal information leakage, or the like.

When the cyber attacks damage a kernel, the cyber attacker may calculatedly take a detour to avoid a virus vaccine, or the leakage of personal information may occur. Thus, the integrity of the kernel should be secured. To secure the integrity of the kernel against the cyber attacks, a processor, such as an application processor (AP), needs to operate by distinguishing an execution area into a normal world and a secure world. The processor may limit the access of the normal world to the resource of the secure world, and may secure the integrity of the kernel using an introspection tool in the secure world.

The above information is presented as background information only to assist with an understanding of the present disclosure. No determination has been made, and no assertion is made, as to whether any of the above might be applicable as prior art with regard to the present disclosure.

### SUMMARY

Although a processor divides an execution environment into a normal world and a secure world, communication between the normal world and the secure world may be required to check the integrity of a kernel stored in the normal world, or to authenticate an electronic device.

However, the normal world and the secure world occupy different virtual address spaces from each other, and thus, the following process needs to be executed to transmit the data of the normal world to the secure world.

The data to be transmitted to the secure world is written in the virtual address space of the kernel of the normal world, and the secure world is informed of a physical address corresponding to the virtual address. The secure world maps a memory frame corresponding to the physical address to a page table so as to generate the virtual address, and reads the data based on the address.

Also, when the secure world desires to access a kernel data structure in the normal world, the secure world converts a virtual address associated with the data structure of the normal world into a physical address, maps the physical address to a page table of the secure world, and accesses the virtual address in the secure world.

As described above, a complex process is required, which is a drawback, and thus, errors occur easily. A page table mapping process in the secure world needs to be performed every time data is shared, and thus, the performance of the processor deteriorates.

Aspects of the present disclosure are to address at least the above-mentioned problems and/or disadvantages and to provide at least the advantages described below. Accordingly, an aspect of the present disclosure is to provide a method of accessing kernel data and an electronic device including a method of accessing kernel data in a normal world through dual memory space accessing (DMSA).

In accordance with an aspect of the present disclosure, a method for an electronic device to access kernel data is provided. The method includes transmitting data associated with a kernel symbol to a secure world that is included in a normal world, determining whether a normal world kernel data observation request exists, when the normal world kernel data observation request exists, adjusting the allocation of a virtual memory address space of the secure world, transmitting the normal world kernel data from the normal world to the secure world, loading the normal world kernel data into a virtual address space of the secure world, linking the data associated with the kernel symbol to the normal world kernel data, and observing the normal world kernel data that is loaded into the virtual address space of the secure world, wherein the data associated with the kernel symbol is included in the normal world when the electronic device is booted.

In accordance with another aspect of the present invention, an electronic device is provided. The electronic device includes a display unit, a wireless communication unit, a storage unit configured to include a normal world and a secure world, and a processor, wherein the processor is configured to when the electronic device is booted, transmit, to the secure world, data associated with a kernel symbol included in the normal world, determine whether a normal world kernel data observation request exists, when the normal world data observation request exists, allocate a virtual memory address of the secure world for the normal world kernel data, transmit the normal world kernel data from the normal world to the secure world, load the normal world kernel data into a virtual address space of the secure world, link data associated with the kernel symbol to the normal world kernel data, and observe the normal world kernel data loaded into the virtual address space of the secure world, and wherein the data associated with the kernel symbol is included in the normal world when the electronic device is booted.

An access method and an electronic device including the method, according to various embodiments of the present disclosure, may access kernel data in a normal world through DMSA, and thus, may improve the performance of a processor.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a flowchart illustrating a kernel data accessing method of an electronic device according to an embodiment of the present disclosure;

FIG. 3 is a diagram illustrating a functional architecture of an electronic device according to an embodiment of the present disclosure;

FIG. 4 is a diagram illustrating an architecture associated with a dual memory space accessing (DMSA) of an electronic device according to an embodiment of the present disclosure; and

FIG. 5 is a diagram illustrating an architecture associated with a virtual address mapping method according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, t those of ordinary skill in the art will recognize that various changes and modifications of various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device, according to an embodiment of the present disclosure, is a device containing a computer resource, which includes, for example, a smart phone, a tablet personal computer (PC), a digital camera, a computer monitor, a personal digital assistant (PDA), an electronic organizer, a desktop PC, a portable multimedia player (PMP), a media player (e.g., a Moving Picture Experts Group phase 1 or phase 2 (MPEG-1 or MPEG-2) audio layer-3 (MP3) player), audio equipment, a wrist watch, a game terminal, a wearable device, home appliances (e.g., a refrigerator, a television (TV), or a washing machine), and the like. The electronic device 100, according to an embodiment of the present disclosure, may include a secure world and a normal world. Hardware (e.g., a memory, a central processing unit (CPU), an application processor (AP), or the like) may be physically or logically distinguished into various areas, and the secure world corresponds to one of the areas. The secure world may be formed of an operating system (OS) to which security technology is applied and hardware and software that operate based thereon. The electronic device may be secured from attacks in the secure world, such as a memory dump, modulation, or the like. The normal world may be one of the hardware areas. Also, the normal world may be formed of a general OS (e.g., Android, Linux, Windows, or the like), and may be formed of hardware and software that operate based thereon.

According to an embodiment of the present disclosure, the normal world may be referred to as a rich execution environment (REE) and the secure world may be referred to as a trusted execution environment (TEE).

According to an embodiment of the present disclosure, an application may be distinguished as a client application and a trusted application. The client application is an application that requests authentication and licensing, and includes all of the applications that are loaded into a memory and are operated as a processor based on a normal (or rich) OS, such as Linux, Android, Windows, or the like. The client application may exist in the normal world (e.g., one of the components of the normal world).

The trusted application may be an application required to secure space operations, or may be a security application that is called to execute security authentication and licensing in association with a process that requires security, such as the attestation or the introspection of integrity of kernel data, and the like. The trusted application may exist in the secure world (e.g., one of the components of the secure world).

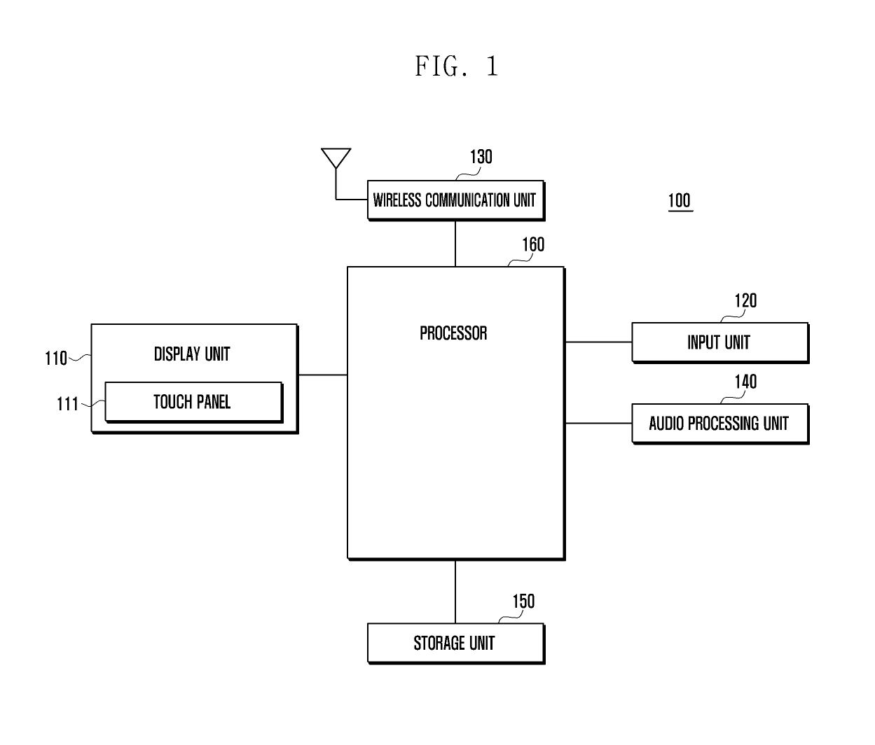

FIG. 1 is a block diagram of an electronic device according to an embodiment of the present disclosure.

Referring to FIG. 1, an electronic device 100 includes a display unit 110, an input unit 120, a wireless communication unit 130, an audio processing unit 140, a storage unit 150, and a processor 160.

The display unit 110 may display data on a screen under the control of the processor 160. When the processor 160 processes data (e.g., decodes data) and stores the data in a buffer, the display unit 110 may convert the data stored in the buffer to an analog signal and may display the converted data on a screen. When power is supplied to the display unit 110, the display unit 110 may display a lock image on the screen. When unlock information is detected in the state in which the lock image is displayed, the processor 160 executes unlocking. The display unit 110 may display, for example, a home image instead of the lock image under the control of the processor 160. The home image may include a background image (e.g., a picture set by a user) and a plurality of icons displayed on the background image. Here, the icons indicate applications or contents (e.g., an image file, a video file, a recording file, a document, a message and the like), respectively. When one of the icons (for example, an icon of a memo application) is touched by a touch input tool, the display unit 110 may display a memo pad under the control of the processor 160.

The display unit 110 may be embodied as a liquid crystal display (LCD), an active matrix organic light emitted diode (AMOLED), a passive matrix organic light emitted diode (PMOLED), a flexible display, or a transparent display.

A touch panel 111 is a touch screen installed in the screen of the display unit 110. Particularly, the touch panel 111 may be embodied as an add-on type that is located on the screen of the display unit 110, or an on-cell type or an in-cell type that is inserted into the display unit 110. The touch panel 111 may generate a touch event in response to a user's gesture with respect to the screen, may perform an analog to digital (A/D) conversion on the touch event, and may transmit the touch event to the processor 160. The touch panel 111 may be a composite touch panel including a hand touch panel that detects a hand's gesture and a pen touch panel that detects a pen's gesture. Here, the hand touch panel may be embodied as a capacitive type. As a matter of course, the hand touch panel may be embodied as a resistive type, an infrared type, or an ultrasonic type. Also, the hand touch panel may not just generate a touch event through a hand's gesture, but may generate a touch event through other objects (for example, a conductive object that may apply a change in a capacitance). The pen touch panel may be embodied as an electromagnetic induction type touch panel. Accordingly, the pen touch panel may generate a touch event by a touch pen that is specially manufactured to form a magnetic field.

The input unit 120 may generate an input event (e.g., a touch event, a key event, or the like) associated with user settings and controlling the functions of the electronic device 100, and may transfer the input event to the processor 160. The input event may include a power on/off event, a volume control event, a screen on/off event, a shutter event, and the like. The processor 160 may control the components in response to the key event.

The wireless communication unit 130 may perform a voice call, a video call, or data communication with an external device through a network under the control of the processor 160. The wireless communication unit 130 may include a wireless frequency transmitting unit for upward converting and amplifying a frequency of a transmitted signal, and a wireless frequency receiving unit for low-noise amplifying and downward converting a frequency of a received signal. Also, the wireless communication unit 130 may include a mobile communication module (e.g., a third-generation (3G) mobile communication module, a 3.5-generation (3.5G) mobile communication module, a fourth-generation (4G) mobile communication module, a digital broadcasting module (e.g., a digital multimedia broadcasting (DMB) module) and a short-range communication module (e.g., a WiFi module, a Bluetooth module or a near field communication (NFC) module). The wireless communication unit 130, according to an embodiment of the present disclosure, may download a client application from an application providing server, and may execute an authentication process by receiving a public key through a security authentication server.

The audio processing unit 140 may input and output an audio signal (e.g., voice data) for voice recognition, voice recording, digital recording, and communication, by coupling a speaker and a microphone. The audio processing unit 140 may receive an audio signal from the processor 160, may digital to analog (D/A)-convert the received audio signal to an analog signal, may amplify the analog signal, and may then output the analog signal to the speaker.

The audio processing unit 140 may A/D-convert an audio signal received from the microphone to a digital signal, and may transmit the digital signal to the processor 160. The speaker may convert an audio signal received from the audio processing unit 140 into a sound wave, and may output the sound wave. The microphone may convert sound waves transferred from a person or other sound sources into audio signals.

The storage unit 150 may be embodied as a disk, a random access memory (RAM), a read only memory (ROM), a flash memory, or the like. The storage unit 150 may include a volatile memory and/or a non-volatile memory. The storage unit 150 may store, for example, instructions or data relevant to at least one other component of the electronic device 100.

According to an embodiment of the present disclosure, the storage unit 150 may include software and programs. The program may include, for example, a kernel, middleware, an application programming interface (API), and/or application programs (or “applications”).

At least some of the kernel, the middleware, and the API may be referred to as an OS.

The kernel may control or manage system resources (e.g., the bus, the storage unit 150, the processor 160, or the like) used for performing operations or functions implemented by the other programs (e.g., the middleware, the API, or the application programs).

Also, the kernel may provide an interface through which the middleware, the API, or the application programs may access the individual components of the electronic device 100 to control or manage the system resources.

The middleware may serve as an intermediary so that the API or the application program, for example, communicates with the kernel and exchanges data. Further, in association with task requests received from the application programs, the middleware may control (e.g., scheduling or load balancing) the task requests, by using, for example, a method of assigning, to at least one of the applications, a priority for using a system resource (e.g., the bus, the storage unit 150, the processor 160, or the like) of the electronic device 100.

The API is an interface through which the application, for example, controls functions provided by the kernel or the middleware, and may include, for example, at least one interface or function (e.g., an instruction) for file control, window control, image processing, text control, or the like.

The storage unit 150 may be formed of a normal world and a secure world. The normal world may be referred to as a main area from the perspective of the structure in which the main OS of the electronic device 100 and applications that operate based thereon are installed. The secure world may be an area that the OS or the applications of the normal world are incapable of accessing arbitrarily to provide write protection and prevent malicious behavior.

The secure world may be formed of a trusted application, a secure OS, and a secure monitor. The trusted applications may be classified as an embedded application and a third-party application. The secure monitor may act as an interface between the normal world and the secure world. According to an embodiment of the present disclosure, for example, TrustZone technology of advanced reduced instruction set computer (RISC) machine (ARM) may be applied as the security monitor. The secure monitor may enable the normal world and the secure world to share an address space. In addition, the trusted application may be a security application that is called to execute security authentication and licensing in association with a process that requires security, such as the attestation or the introspection of integrity of kernel data, and the like. The trusted application may exist in the secure world (e.g., one of the components of the secure world).

Secure world user data may be data that is generated by a secure core and a trusted application. The secure world user data may be accessed by a secure core, a security application, and a secure monitor, and may not be accessed by the normal world.

The secure OS may include a module manager and a kernel module. The module manager loads normal world kernel data received from the normal world into an address space of the secure world, and the kernel module may link the normal world kernel data to a kernel symbol. The kernel module may observe the normal world kernel data loaded into the secure world.

The normal world may store normal world user data and normal world kernel data in a virtual address space. The addresses of the normal world user data and the normal world kernel data in the virtual address space may be stored in a normal world page table.

The secure world may provide a hardware register (e.g., translation table base register (TTBR)) indicating a page table that an execution context may use. The secure world may include a hardware register such as a translation table base configuration register (TTBCR) and two TTBRs (TTBR0 and TTBR1). The hardware registers in the processor may be configured to be unavailable to the normal world via write protection. The TTBR, TCBCR, TTBR0, and TTBR1 are configured such that they can only be accessed via the secure world.

Through the secure world TTBCR register, access to secure world TTBR0 and TTBR1 registers may be defined. According to an embodiment of the present disclosure, the secure world TTBCR register divides a memory address space, and enables at least one of the secure world TTBR0 and the secure world TTBR1 register to indicate a page table address of data (e.g., secure world user data and secure world kernel data) required for the operations of the secure world.

Also, the secure world TTBCR register enables at least one of the secure world TTBR0 register and the secure world TTBR1 register, which does not store data required for the operations of the secure world, to indicate a page table address of the normal world.

The normal world may include a user space and a kernel. The user space may include a client application.

The client application may operate based on a normal OS, and the client application may be classified as an embedded application and a third party application. For example, the embedded application includes a Web browser, an E-mail program, an instant messenger, and the like. Normal world user data may include data generated by the normal OS and the client application, data required to execute the normal OS and the client application, and data received from an external device through the wireless communication unit 130.

The kernel may include a TEE driver. The TEE driver may transmit, to the secure world, kernel symbol data (e.g., a symbol table) when the electronic device 100 is booted. Particularly, the TEE driver may transmit, to the module manager of the secure world, kernel symbol data (e.g., a symbol table) when the electronic device 100 is booted.

The normal world may store normal world user data and normal world kernel data in a virtual address space. The addresses of the normal world user data and the normal world kernel data in the virtual address space may be stored in a normal world page table.

The normal world may provide a register (TTBR) indicating a page table that an execution context may use. The normal world may include a normal world TTBCR register and two secure world TTBRs (secure world TTBR0 and secure world TTBR1).

Through the normal world TTBCR register, access to the TTBR0 and TTBR1 registers may be controlled.

The processor 160 controls general operations of the electronic device 100 and a signal flow among internal components of the electronic device 100, performs a function of processing data, and controls supplying power to the components from a battery.

The processor 160 may be formed of one or more CPUs. The CPU is a core control unit of a computer system that performs calculations and comparisons of data, the interpretation and execution of instructions, and the like. Also, the CPU may be a single package in which one or more independent cores are integrated as a single integrated circuit.

According to an embodiment of the present disclosure, the processor 160 may include a ROM and a main memory unit. The ROM is a component that is capable of executing an initial booting-up process, and may include a ROM bootloader, a core root trust measurement (CRTM), and a secure hash. The ROM bootloader may execute a function of forming an initial configuration of a system at the time of turning on the power or resetting the electronic device 100. The ROM bootloader may load a trusted program and secure world user data of the storage unit 150 into a main memory. The CRTM may execute a function of measuring the integrity of the components, such as secure bootloader that is loaded by the ROM bootloader into the main memory, or the like.

The main memory may be embodied as, for example, a RAM or the like. The CPU of the processor 160 may access the main memory to read various programs and data loaded into the main memory, may interpret instructions of the read program, and may execute a function based on a result of the interpretation.

The processor 160, according to an embodiment of the present disclosure, may execute a control to transmit, to the secure world, data associated with the kernel symbol included in the normal world at the time of booting-up. The processor 160 determines whether a normal world kernel data observation request exists, and when the normal world kernel data observation request exists, adjusts the allocation of a virtual memory address space of the secure world where the normal world kernel data may be stored. The processor 160 may transmit the normal world kernel data from the normal world to the secure world. The processor 160 may load the normal world kernel data to a virtual address space of the secure world, and link data associated with a kernel symbol to the normal world kernel data. The processor 160 may observe the normal world kernel data loaded into the virtual address space of the secure world.

The processor 160, according to an embodiment of the present disclosure, may execute allocation so as to store the normal world kernel data in some address of a virtual space of the secure world, through the secure world TTBCR register.

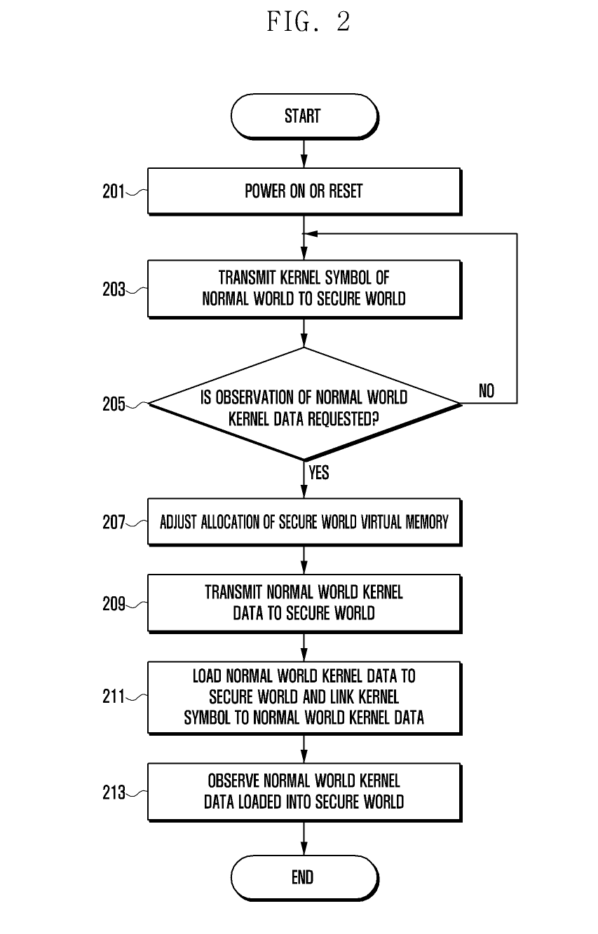

FIG. 2 is a flowchart illustrating a kernel data accessing method of an electronic device according to an embodiment of the present disclosure.

Referring to FIGS. 1 and 2, the electronic device 100 is powered on or reset in operation 201. Accordingly, the booting-up process of the electronic device 100 may begin.

The electronic device 100 transmits, to a secure world, data associated with a kernel symbol included in a normal world at the time of booting-up, under the control of the processor 160, in operation 203.

According to an embodiment of the present disclosure, the electronic device 100 transmits, to a module manager of the secure world, data (e.g., a symbol table) associated with a kernel symbol included in the normal world through a TEE driver of the normal world at the time of booting-up, under the control of the processor 160, in operation 203.

The electronic device 100 determines whether a normal world kernel data observation is requested by a client application or a trusted application, under the control of the processor 160, in operation 205. The kernel data observation request may be the introspection of the integrity of the kernel data.

When the normal world kernel data observation request does not exist, the electronic device 100 proceeds with operation 203.

When the normal world kernel data observation request exists, the electronic device 100 adjusts the allocation of a virtual memory address space of the secure world so as to store the normal world kernel data, under the control of the processor 160, in operation 207.

According to an embodiment of the present disclosure, through the secure world TTBCR register, the electronic device 100 enables at least one of the secure world TTBR0 register and the secure world TTBR1 register to indicate a page table address of data (e.g., secure world user data and secure world kernel data) required for the operations of the secure world, and enables the secure world TTBR register, which does not indicate a page table address of the secure world TTBCR register where the data required for the operations of the secure world is not stored, to indicate a page table address value of the normal world, under the control of the processor 160, in operation 207.

The electronic device 100 transmits the normal world kernel data from the normal world to the secure world, under the control of the processor 160, in operation 209.

According to an embodiment of the present disclosure, the electronic device 100 transmits the normal world kernel data to the module manager of the secure world through a secure monitor, under the control of the processor 160, in operation 209.

The electronic device 100 loads the normal world kernel data to a virtual address space of the secure world, and links data associated with a kernel symbol to the normal world kernel data, under the control of the processor 160, in operation 211.

According to an embodiment of the present disclosure, the electronic device 100 uses a module manager to load the normal world kernel data to a virtual address space of the secure world, and uses a kernel module to link data associated with a kernel symbol to the normal world kernel data loaded to the virtual address space, under the control of the processor 160, in operation 211. The kernel module links the normal world kernel data loaded to the virtual address space to the data associated with the kernel symbol.

The kernel module is formed in an executable and linking format (ELF) through module building of the normal world kernel data. The kernel module is formed in the ELF, and thus, the secure world may use the macro and the data type of the normal world kernel data, and may access the normal world kernel data using a kernel symbol.

The electronic device 100 observes the normal world kernel data loaded in the virtual address space of the secure world, under the control of the processor 160, in operation 213.

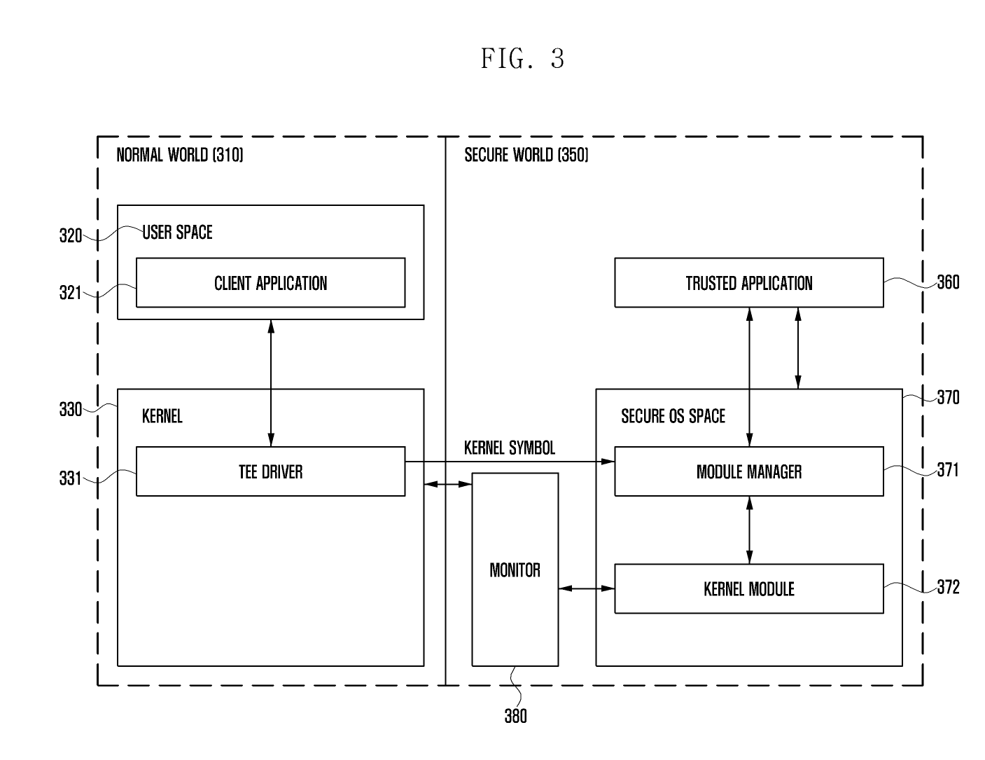

FIG. 3 is a diagram illustrating a functional architecture of an electronic device according to an embodiment of the present disclosure.

Referring to FIG. 3, a normal world 310 includes a user space 320 and a kernel space 330. The user space 320 includes at least one client application 321.

The client application 321 may operate based on a normal OS, and the client application 321 may be classified as an embedded application and a third party application. For example, the embedded application includes a Web browser, an E-mail program, an instant messenger and the like. Data required for the execution of the client application 321 and data received from an external device through the wireless communication unit 130 may be stored.

The kernel space 330 may control or manage system resources used for executing operations or functions implemented in other programs. The kernel space 330 may provide an interface through which the middleware, the API, or the application programs may access the individual components of the electronic device 100 to control or manage the system resources.

The kernel space 330 includes a TEE driver 331. The TEE driver 331 transfers, to a module manager 371 of the secure world, data associated with a kernel symbol, which is stored in the kernel space 330, at the time of booting-up of the electronic device 100.

The secure world 350 includes a trusted application 360, a secure OS space 370, and a secure monitor 380. The trusted application 360 may be an application required for the operations of the secure world 350, or may be a security application that is called to execute security authentication and licensing in association with a process that requires security, such as the attestation or the introspection of integrity of kernel data, and the like.

The secure OS space 370 is an OS to which security technology is applied. The secure OS space 370 includes the module manager 371 and a kernel module 372.

The module manager 371 loads normal world kernel data received from the normal world 310 into an address space of the secure world 350, and the kernel module 372 links the normal world kernel data to a kernel symbol. The kernel module 372 may observe the normal world kernel data that is loaded into the secure world.

The secure monitor 380 may act as an interface between the normal world 310 and the secure world 350. The secure monitor 380 may enable the normal world 310 and the secure world 350 to share an address space.

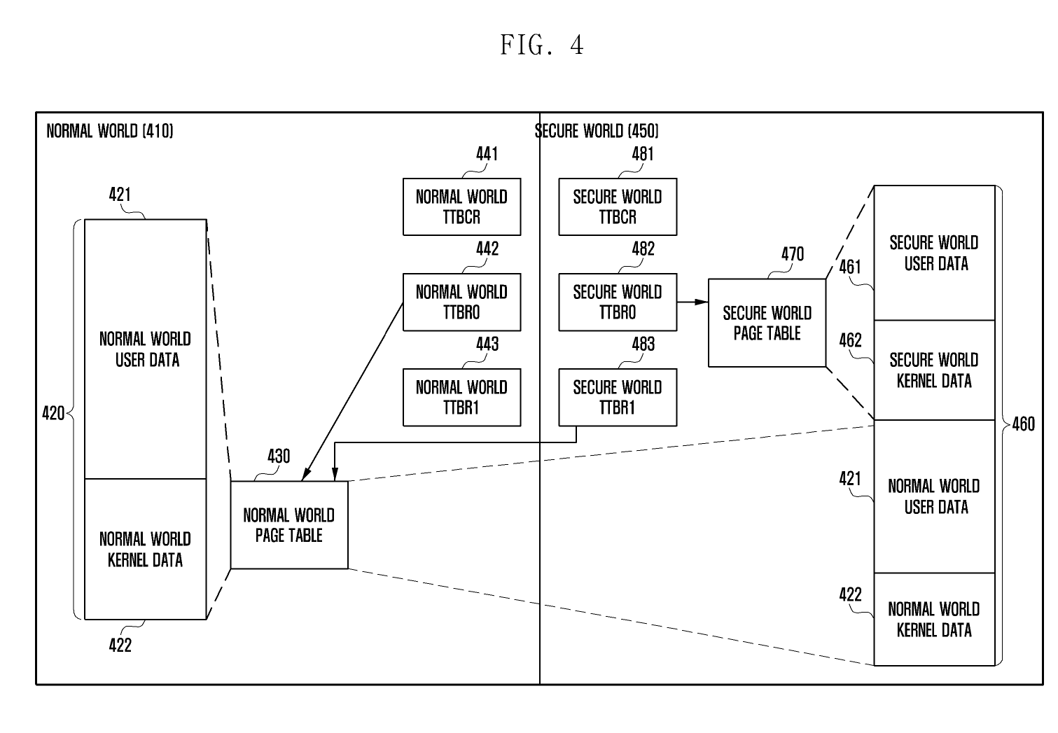

FIG. 4 is a diagram illustrating an architecture associated with a dual memory space accessing (DMSA) of an electronic device according to an embodiment of the present disclosure.

Referring to FIG. 4, a normal world 410 includes a normal world virtual address space 420. The normal world virtual address space 420 may store normal world user data 421 and normal world kernel data 422. A normal world page table 430 may store addresses or data structures of the normal world user data 421 and the normal world kernel data 422, which exist in the normal world virtual address space 420.

A normal world TTBCR 441 may define how a normal world TTBR0 442 and a normal world TTBR1 443 are to be used. For example, the normal world TTBCR 441 enables the normal world TTBR0 442 to indicate the normal world page table 430 that store the addresses or data structures of the normal world user data 421 and the normal world kernel data 422 existing in the normal world virtual address space 420.

A secure world 450 includes a secure world virtual address space 460.

The secure world virtual address space 460 may store secure world user data 461, secure world kernel data 462, and the normal world user data 421 and the normal world kernel data 422, which are received from the normal world.

A secure world page table 470 may store addresses or data structures of the secure world user data 461 and the secure world kernel data 462, which exist in the secure world virtual address space 460.

A secure world TTBCR 481 may define how a secure world TTBR0 482 and a secure world TTBR1 483 are to be used. For example, the secure world TTBCR 481 enables the secure world TTBR0 442 to indicate the secure world page table 470 that store the addresses or data structures of the secure world user data 461 and the secure world kernel data 462, which exist in the secure world virtual address space 460. The secure world TTBCR 481 may enable the secure world TTBR1 483 to indicate the normal world page table 430 that stores the addresses or data structures of the normal world user data 421 and the normal world kernel data 422.

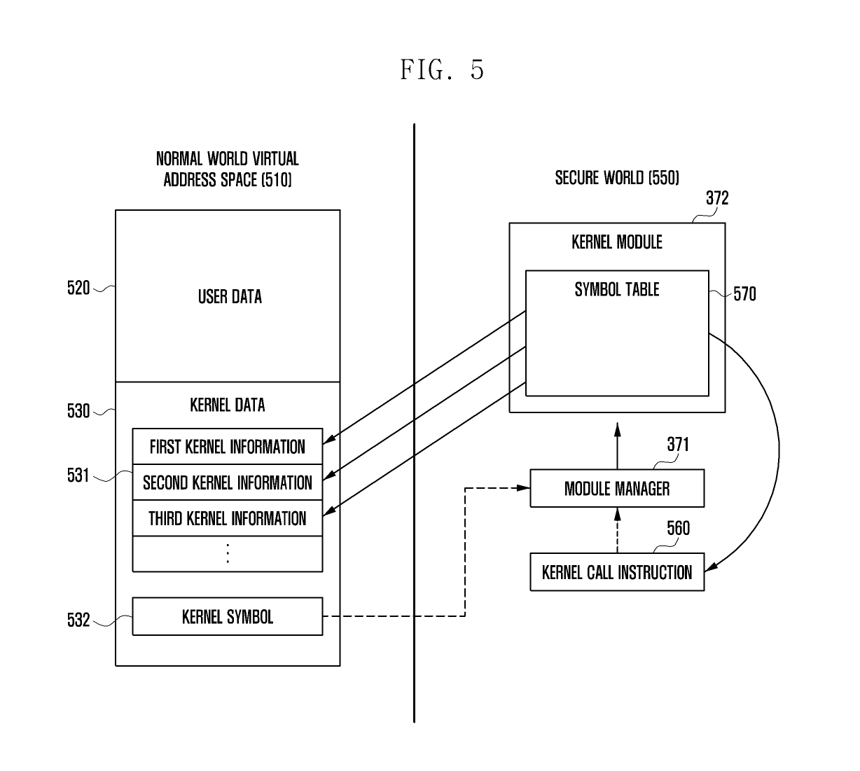

FIG. 5 is a diagram illustrating an architecture associated with a virtual address mapping method of an electronic device according to an embodiment of the present disclosure.

Referring to FIG. 5, a normal world virtual address 510 may include normal world user data 520 and normal world kernel data 530. The normal world kernel data 530 may include at least one kernel information 531 and data 532 associated with a kernel symbol.

The kernel symbol 532 may be transferred to the module manager 371 of a secure world 550 when the electronic device 100 is booted up. When a kernel call instruction 560 that instructs observation of normal world kernel data is transferred to the module manager 371, the module manager 371 may load at least one kernel information 531 into a virtual address space of the secure world 550. When the module manager 371 controls the kernel module 372, the module manager 371 may execute a control to enable the kernel module 372 to link data associated with a kernel symbol (e.g., a symbol table 570) to correspond to at least one kernel information 531.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for an electronic device to access kernel data, the method comprising:
transmitting data associated with a kernel symbol to a secure world that is included in a normal world;
determining whether a normal world kernel data observation request exists;
when the normal world kernel data observation request exists, adjusting allocation of a virtual memory address space of the secure world;
transmitting the normal world kernel data from the normal world to the secure world;
loading the normal world kernel data into a virtual address space of the secure world;
linking the data associated with the kernel symbol to the normal world kernel data; and
observing the normal world kernel data that is loaded into the virtual address space of the secure world,
wherein the data associated with the kernel symbol is included in the normal world when the electronic device is booted.

2. The method of claim 1, wherein the transmitting of the data associated with the kernel symbol comprises:
transmitting the data associated with the kernel symbol to a module manager of the secure world through a trusted execution environment (TEE) driver included in a kernel of the normal world.

3. The method of claim 1, wherein the adjusting of the allocation of the virtual memory address space of the secure world comprises:
storing an address in a first register, the address corresponding to a location of the kernel data,
wherein the first register is unavailable from the normal world.

4. The method of claim 3, wherein the executing of the allocation through the first register so as to store the normal world kernel data in some address of the virtual space of the secure world comprises:
configuring a second register to store a page table address of data required for an operation of the secure world; and
configuring a third register to store a page table address of the normal world.

5. The method of claim 1, wherein the transmitting of the normal world kernel data from the normal world to the secure world comprises:
transmitting the normal world kernel data to a module manager of the secure world through a secure monitor.

6. The method of claim 5, wherein the loading of the normal world kernel data into the virtual address space of the secure world, and the linking of the data associated with the kernel symbol to the normal world kernel data comprises:
loading the normal world kernel data into the virtual address space of the secure world through a module manager.

7. The method of claim 6, wherein the loading of the normal world kernel data into the virtual address space of the secure world, and the linking of the data associated with the kernel symbol to the normal world kernel data comprises:
linking the normal world kernel data loaded into the virtual address space to the data associated with the kernel symbol through a kernel module of the secure world.

8. The method of claim 7, wherein the kernel module is formed in an executable and linking format (ELF) through module building of the normal world kernel data.

9. An electronic device comprising:
a display unit;
a wireless communication unit;
a storage unit configured to include a normal world and a secure world; and
a processor,
wherein the processor is configured to:
when the electronic device is booted, transmit, to the secure world, data associated with a kernel symbol included in the normal world;
determine whether a normal world kernel data observation request exists;
when the normal world data observation request exists, allocate a virtual memory address of the secure world for the normal world kernel data;
transmit the normal world kernel data from the normal world to the secure world;
load the normal world kernel data into a virtual address space of the secure world;
link data associated with the kernel symbol to the normal world kernel data; and
observe the normal world kernel data,
wherein the data associated with the kernel symbol is included in the normal world when the electronic device is booted.

10. The electronic device of claim 9, wherein the processor is further configured to transmit the data associated with the kernel symbol to a module manager of the secure world through a trusted execution environment (TEE) driver included in a kernel of the normal world.

11. The electronic device of claim 9, wherein the processor is further configured to execute allocation through a first register to store the user kernel data.

12. The electronic device of claim 11, wherein the processor is further configured to:
configure one of a second register to store a page table address of data required for an operation of the secure world; and
configure a third register to indicate a page table address of the normal world,
wherein the second register and the third register are configured to be unavailable to the normal world.

13. The electronic device of claim 9, wherein the processor is further configured to transmit the user kernel data to a module manager of the secure space through a secure monitor.

14. The electronic device of claim 13, wherein the processor is further configured to load the user space kernel data into the virtual address space of the secure space through the module manager.

15. The electronic device of claim 15, wherein the processor is further configured to link, through a kernel module of the secure space, the user kernel data that is loaded to the virtual address space to the data associated with the kernel symbol.

16. The electronic device of claim 15, wherein the kernel module is formed in an executable and linking format (ELF) through module building of the user kernel data.
